(19) United States
(12) Patent Application Publication
(10) Pub. No.: US 2024/0375005 A1
(43) Pub. Date: Nov. 14, 2024

(54) Systems and Methods for Polygon-Based Pathfinding with Different Movement Speeds

(71) Applicant: Six Impossible Things Before Breakfast Limited, Dublin (IE)

(72) Inventors: Sherry IGNATCHENKO, Weidling (AT); Dmytro IVANCHYKHIN, Kiev (UA)

(73) Assignee: Six Impossible Things Before Breakfast Limited, Dublin (IE)

(21) Appl. No.: 18/657,013

(22) Filed: May 7, 2024

Related U.S. Application Data
(60) Provisional application No. 63/500,799, filed on May 8, 2023.

(51) Int. Cl. A63F 13/56

(52) U.S. Cl. CPC A63F 13/56

(57) ABSTRACT

Systems and methods for identifying a path for a game object in two-dimensional polygon space in which the polygons making up the two-dimensional polygon space have different movement speeds are described herein. To find an optimal path, a graph may be generated for a two-dimensional polygon space including a polygon for at least each area associated with a different movement speed. A set of routing points may be added along each boundary between the polygons, and a set of segments may be identified between the routing points and each of the starting point and ending point. For each of the individual segments, a cost may be calculated that corresponds to a minimum time required to travel between the routing point and either the starting point or ending point. Using a graph search method, an optimal path along at least one segment in each polygon may be identified.

### RELATED APPLICATIONS

This application claims priority to U.S. Provisional Application No. 63/500,799, entitled “Method for Polygon-Based Pathfinding with Different Movement Speeds,” filed on May 8, 2023, the content of which is hereby incorporated herein by reference in its entirety.

### FIELD OF THE DISCLOSURE

The systems and methods described herein relate to the use of polygon-based pathfinding to identify a path for a game object in an online game.

### BACKGROUND

In online games, pathfinding is the process by which a path for a character, vehicle, or other game object between two points is determined. Polygon-based pathfinding is a commonly-used method of pathfinding in online games. Polygon-based pathfinding is a technique in which a list of “routing points” is created using a two-dimensional polygonal map. These “routing points” include all “concave” vertices of polygons, plus current target points (i.e., the two points between which a path is sought or, in other words, “from” and “to” points). From the two-dimensional polygonal map, a graph is created with a node for each routing point. For each pair of routing points, polygon-based pathfinding seeks to determine if a line segment between the routing points is a valid segment (i.e., the line segment does not intersect any polygons). If the segment is valid, a corresponding path (or edge) is added to the graph, with the “cost” of the edge being the length of the segment. After the graph is created, polygon-based pathfinding may use any of the existing methods for finding an optimal path within the graph, such as, for example, one of the A* family of graph search methods, breadth first search (BFS), Dijkstra's algorithm, and/or other similar graph traversal and path search algorithms.

While polygon-based pathfinding is an efficient method, it implicitly depends on the notion that the best (lowest-cost) path between two points is a straight line. Put differently, it works fine if the “cost” optimized for is based solely on path length. If the optimal path is instead based on time, traditional polygon-based pathfinding is sub-optimal as different areas may be associated with different speeds. As such, there is a need for an improved pathfinding technique to identify an optimal path when polygons include different movement speeds.

### SUMMARY OF THE DISCLOSURE

This disclosure relates to systems and methods for identifying a path for a game object in two-dimensional polygon space. According to one aspect of the invention, the systems and methods described herein may be configured to determine an optimal path for a game object in a two-dimensional polygon space in which the polygons making up the two-dimensional polygon space have different movement speeds. In various implementations, segments (or sub-segments) representing possible paths to be traversed may be identified and a cost associated with a graph edge corresponding to the identified segments (or sub-segments) may be calculated. In various implementations, a starting point and an ending point between which a game object is to travel in an online game may be identified. As described herein, in certain circumstances, the starting point may be located in one area within the online game associated with one movement speed, and the ending point may be located in another area associated with a different movement speed. Each of the areas in which the game object may travel may be represented by a two-dimensional polygon. To find an optimal path, the systems and methods described herein are configured to generate a graph based on candidate points including at least the starting point and ending point, as well as any concave points of polygons through which the object may pass. A set of routing points may be added along each boundary between the polygons, and a set of segments may be identified between the routing points, and/or between routing points and each of the starting point and ending point. For each edge of the graph associated with those segments, a cost may be calculated that corresponds to a minimum time required to travel between the routing point and either the starting point or ending point, or between two routing points. For example, the cost associated with an edge may be calculated by dividing a length of a corresponding segment by a movement speed associated with the polygon in which the segment is located. Based on the graph and the costs calculated for the given graph edges, an optimal path may be identified between the starting point and the ending point comprising at least one segment for each of the polygons. In various implementations, the path in the online game between the starting point and the ending point may be identified by performing a graph search method. For example, the graph search method may comprise one of the A* family of graph search methods.

According to another aspect of the invention, the systems and methods described herein may be configured to determine an optimal path for a game object in a two-dimensional polygon space by performing a graph search method using only local traversing. For example, the optimal path may be determined by performing a graph search method that analyzes only graph edges between the starting point and any neighboring points and between any neighboring points and subsequent neighboring points until the ending point is reached. In various implementations, a cost may be determined for only graph edges that do not cross from a polygon representing one area within the online game associated with a first movement speed and another polygon representing another area within the online game associated with a second movement speed. In some implementations, determining the cost of a graph edge may include determining whether the graph edge is included within a cache of valid graph edges. In some implementations, determining the cost of a graph edge may include calculating a cost of the graph edge by dividing a length of a line segment corresponding to the graph edge by a movement speed associated with an area in which the line segment is located within the online game. In various implementations, the graph search method may comprise one of the A* family of graph search methods.

These and other objects, features, and characteristics of the systems and/or methods disclosed herein, as well as the methods of operation and functions of the related elements of structure and the combination thereof, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a block diagram of an example of a system configured to identify a path for a game object in two-dimensional polygon space having polygons associated with different movement speeds, according to one or more aspects described herein;

FIG. 2 depicts a diagram illustrating an example two-dimensional polygon space representing an area to be traversed in an online game;

FIG. 3 depicts a diagram illustrating the example two-dimensional polygon space depicted in FIG. 2 with additional routing points added to identify an optimal path, according to one or more aspects described herein;

FIG. 4 depicts a diagram illustrating the example two-dimensional polygon space depicted in FIG. 2 with additional variables included that are used to perform per-segment optimization, according to one or more aspects described herein;

FIG. 5 depicts a flow diagram of an example of a method for identifying a path for a game object in two-dimensional polygon space having polygons associated with different movement speeds, according to one or more aspects described herein;

FIG. 6 depicts a flow diagram of an example of a method for identifying a path for a game object in two-dimensional polygon space by performing a graph search method using only local traversing, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and ease of illustration, these drawings are not necessarily drawn to scale.

### DETAILED DESCRIPTION

Certain illustrative aspects of the systems and methods according to the present invention are described herein in connection with the following description and the accompanying figures. These aspects are indicative, however, of but a few of the various ways in which the principles of the invention may be employed and the present invention is intended to include all such aspects and their equivalents. Other advantages and novel features of the invention may become apparent from the following detailed description when considered in conjunction with the figures.

In the following detailed description, numerous specific details are set forth in order to provide a thorough understanding of the invention. In other instances, well known structures, interfaces, and processes have not been shown in detail in order not to unnecessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention. Although certain embodiments of the present disclosure are described, these embodiments likewise are not intended to limit the full scope of the invention.

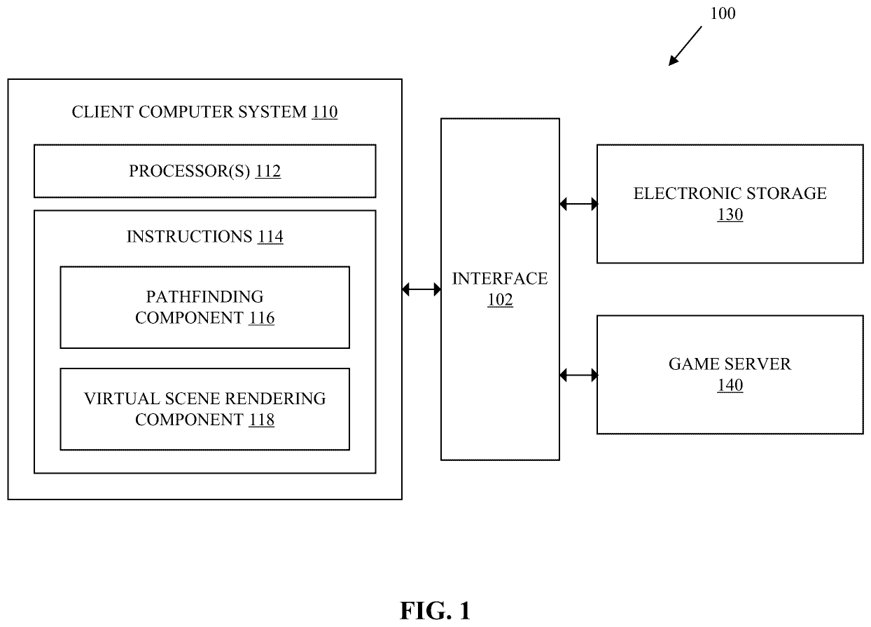

FIG. 1 illustrates an example of a system 100 configured to identify a path for a game object in two-dimensional polygon space having polygons associated with different movement speeds, according to one or more aspects described herein. In various implementations, system 100 may include one or more of interface 102, a client computer system 110, electronic storage 130, a game server 140, and/or other components. In various implementations, client computer system (or device) 110 may comprise a game client computing system (or device). In some implementations, client computer system 110 may be configured to receive instructions and game state data related to an online game comprising three-dimensional virtual scenes from game server 140. In various implementations, client computer system 110 may include one or more physical processors 112 (also interchangeably referred to herein as processor(s) 112, processor 112, or processors 112 for convenience), computer readable instructions 114, and/or one or more other components. In some implementations, system 100 may include one or more external resources, such as sources of information outside of system 100, external entities participating with system 100, and/or other resources. In various implementations, system 100 may be configured to receive input from or otherwise interact with one or more users via client computer system 110 and/or game server 140.

In various implementations, physical processor(s) 112 may be configured to provide information processing capabilities in system 100. As such, the processor(s) 112 may comprise one or more of a digital processor, an analog processor, a digital circuit designed to process information, a central processing unit, a graphics processing unit, a microcontroller, a microprocessor, a field programmable gate array (FPGA), an application specific transformed circuit (ASIC), a System on a Chip (SoC), and/or other mechanisms for electronically processing information. Processor(s) 112 may be configured to execute one or more computer readable instructions 114. Computer readable instructions 114 may include one or more computer program components. In various implementations, computer readable instructions 114 may include one or more of a pathfinding component 116, a virtual scene rendering component 118, and/or other computer program components. As used herein, for convenience, the various computer readable instructions 114 will be described as performing an operation, when, in fact, the various instructions program the processor(s) 112 (and therefore system 100) to perform the operation.

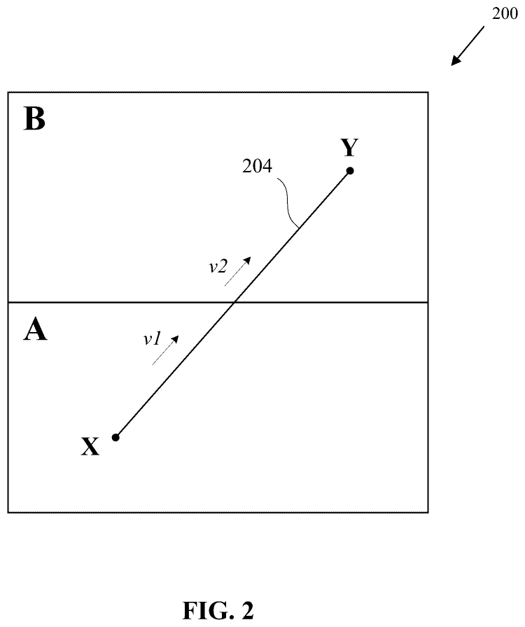

In various implementations, pathfinding component 116 may be configured to identify a path for a game object in an online game. A path may be identified by determining the path with the shortest distance between two points, a shortest time to travel between the two points, and/or a combination of the two. This path may be referred to herein as the “optimal path” as it comprises the path with the shortest time to travel between two points from among valid paths identified between those two points. As used herein, the term “optimal path” encompasses a “near-optimal path” in the sense that a path chosen may ultimately represent a path within an acceptable margin of error of a truly optimal path. In various implementations, pathfinding component 116 may be configured to determine an optimal path for a game object in a two-dimensional polygon space in which the polygons making up the two-dimensional polygon space have different movement speeds. For example, FIG. 2 depicts a two-dimensional polygon space 200 representing an area to be traversed in an online game (e.g., between point X and point Y). Two-dimensional polygon space 200 may comprise a polygon A in which one or more types of game objects may be permitted to travel at a first maximum speed ν1 and a polygon B in which the same one or more types of game objects may be permitted to travel at a second maximum speed ν2. In an example implementation, polygon A may correspond to land and may be associated with a maximum speed of 4 m/s, whereas polygon B may correspond to a body of water (e.g., such as a river, lake, or ocean) and may be associated with a maximum speed of 1 m/s.

Using conventional polygon-based pathfinding, the only two routing points would be the “to” and “from” target points (i.e., point X and point Y). As such, the only possible path would be the segment representing a straight line between point X and point Y (i.e., a path 204). While this is a valid path, this would not be the “optimal” path in the current example because of the different speeds associated with polygon A and polygon B. Using the improved technique described herein, pathfinding component 116 may be configured to identify the “optimal” path.

As described herein, pathfinding component 116 may be configured to identify segments (or sub-segments) representing possible paths to be traversed (e.g., within two-dimensional polygon space 200) and calculate a cost associated with graph edges corresponding to the identified segments. For example, using conventional polygon-based pathfinding, the cost associated with a graph edge corresponding to a segment (or path) between point X and point Y may simply be the distance between point X and point Y (or the length of path 204). Using the improved technique described herein, pathfinding component 116 may be configured to identify a path between point X and point Y comprising at least two sub-segments-a sub-segment representing a path within polygon A and a sub-segment representing a path within polygon B.

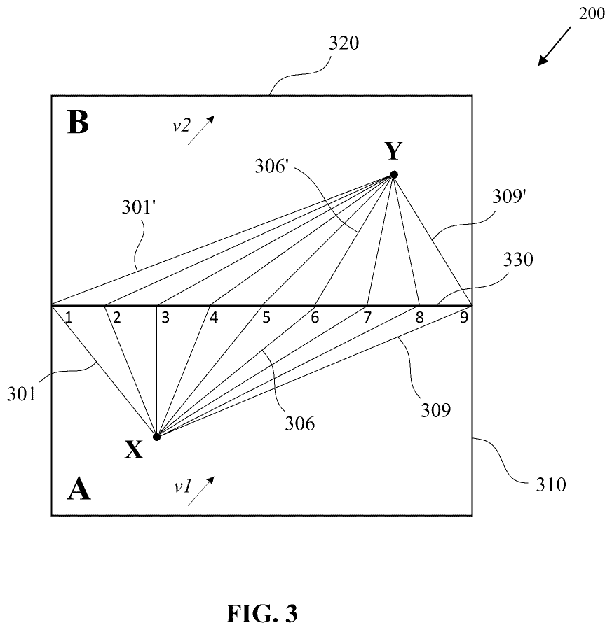

In various implementations, pathfinding component 116 may be configured to place additional routing points on two-dimensional polygon space 200. For example, FIG. 3 depicts two-dimensional polygon space 200 with additional routing points added to identify an optimal path, according to one or more aspects described herein. In a two-dimensional polygon space representing an area to be traversed in an online game (e.g., such as two-dimensional polygon space 200), the one or more polygons may include hard boundaries that cannot be crossed, such as the outer boundaries of an area or virtual scene, and soft boundaries that may be crossed, such as the border between two polygons that may be traversed. For example, as depicted in FIG. 3, two-dimensional polygon space 200 may include hard boundaries 310 and 320, representing an outside boundary of two-dimensional polygon space 200 and of polygon A and polygon B, respectively, as well as a soft boundary 330, representing a border between polygons A and B that may be traversed. In various implementations, pathfinding component 116 may be configured to add additional routing points on each soft boundary between the different polygons to be traversed. For example, pathfinding component 116 may be configured to add additional routing points 1, 2, . . . , 8, and 9 on boundary 330, which is the boundary that may be traversed between polygon A and polygon B to travel between the “to” and “from” target points (i.e., point X and point Y).

In various implementations, pathfinding component 116 may be configured to determine the locations of the additional routing points by splitting the segment between polygons (e.g., boundary 330) into roughly equal parts. Stated differently, pathfinding component 116 may be configured to add additional routing points to a segment (or boundary) between polygons at locations equally spaced, or substantially the same distance, apart. For example, as depicted in FIG. 3, pathfinding component 116 may be configured to add routing points 1-9 such that each of the nine routing points are equally spaced apart. In other implementations, pathfinding component 116 may be configured to add routing points to a boundary between polygons at varying distances apart. In some implementations, pathfinding component 116 may be configured to add a routing point at each intersection of a soft boundary with a hard boundary (e.g., such as routing points 1 and 9).

In some implementations, pathfinding component 116 may be configured to determine the number of additional routing points to be added and/or the location of additional routing points to be added based on the cost associated with the graph edge for segment(s) between a “to” or “from” target point (i.e., either point X or point Y) and a possible additional routing point. For example, pathfinding component 116 may be configured to only add additional routing points for which the resulting segment(s) (i.e., the path between one or both target points and the additional routing points) is within a maximum allowable routing error, which may be based on distance and/or time. For example, in some implementations, a maximum allowable routing error may be based on distance, in which the maximum allowable routing error may simply comprise a maximum size of created sub-segments S. In other implementations, a maximum allowable routing error may be based on time, in which a maximum size of created sub-segments S may be defined as:

$$S \leq \frac{max\_time \_error}{( \frac{1}{v 1} + \frac{1}{v 2} )} = \frac{v 1 * v 2 * max\_time \_error}{( v 1 + v 2 )} ,$$

where ν1 and ν2 are speeds in polygon A and polygon B, respectively.

In various implementations, pathfinding component 116 may be configured to identify segments (or sub-segments) representing possible paths to be traversed (e.g., within two-dimensional polygon space 200). To do so, in some implementations, pathfinding component 116 may not consider any segments that traverse polygons with different speeds or that do not intersect (i.e., begin or end at) a routing point along a boundary between polygons. Thus, each segment identified by pathfinding component 116 may comprise a segment that completely belongs to one single polygon. As a result, pathfinding component 116 may be configured to calculate a cost associated with a graph edge for each segment (in terms of time) by dividing a length of each segment by the speed at which a game object is able to travel in the polygon in which the segment is located.

In the example implementation depicted in FIG. 3, pathfinding component 116 may be configured to identify segments within two-dimensional polygon space 200 between target points X and Y and additional routing points 1-9. As used herein, segments within two-dimensional polygon space 200 may also be referred to interchangeably as “edges” or “graph edges.” Indeed, when analyzing a graph generated as described herein, geographical line segments (or “segments”) become graph edges for which a cost may be calculated and used to identify a path between points. For example, pathfinding component 116 may be configured to identify edges 301, . . . , and 309 between target point X and respective routing points 1, . . . , and 9, and identify edges 301′, . . . , and 309′ between respective routing points 1, . . . , and 9 and target point Y.

In various implementations, pathfinding component 116 may be configured to determine an optimal path for a game object between point X and point Y in an area to be traversed represented by two-dimensional polygon space 200 by identifying a pair of edges (i.e., one edge 301, . . . , and 309 representing a path through polygon A and one edge 301′, . . . , 309′ representing a path through polygon B). In various implementations, pathfinding component 116 may be configured to determine the optimal path based on the cost of each sub-segment (or edge) to identify the path taking the shortest amount of time to travel between point X and point Y. For example, in the example implementation depicted in FIG. 3, pathfinding component 116 may be configured to identify the path through routing point 6 (i.e., comprising edge 306 through polygon A and edge 306′ through polygon B) as the optimal path between point X and point Y from among the paths identified through the various additional routing points added to the graph. In various implementations, pathfinding component 116 may be configured to use any of the existing methods for finding an optimal path within the resulting graph, such as, for example, one of the A* family of graph search methods, breadth first search (BFS), Dijkstra's algorithm, and/or other similar graph traversal and path search algorithms. As used herein, the A* family of graph search methods may include A*, iterative deepening A* (IDA*), simplified memory bounded A* (SMA*), and/or other A*-based graph traversal and path search algorithms. For the graph search method, pathfinding component 116 may be configured to use a heuristic function that corresponds to a distance in two-dimensional space from the point that corresponds to a current node, to the target point, divided by maximum speed within any polygons present in the map.

For ease of understanding, the systems and methods described herein may be described in terms of a set of target points (e.g., a set of “from” and “to” points), each located in a different area associated with a different speed, between which pathfinding component 116 may be configured to identify an optimal path through the two polygons associated with the only two areas. However, in various implementations, the techniques described herein may also be applied where a game object must pass through or travel within more than two areas (or corresponding polygons) to travel between the starting point and the ending point and/or where individual polygons include one or more hard boundaries around which a game object must travel to move through or within a corresponding area. Accordingly, in various implementations, pathfinding component 116 may be configured to consider all candidate points when identifying a path between a starting point and an ending point. As used herein, a “candidate point” may include target points (e.g., the starting point and the ending point) as well as any concave points of the polygons that the game object may pass through or travel within to travel between the starting point and the ending point. As used herein, a “concave point” may comprise a point between hard boundaries within or along an outer edge of a polygon that may define an outer edge of an obstacle for pathfinding purposes. In various implementations, for each boundary between the polygons which the game object may pass through or travel within (including the polygons in which the starting point and ending point are located and any intervening polygons), pathfinding component 116 may be configured to place additional routing points. These routing points may also be considered “candidate points.” Then, pathfinding component 116 may be configured to identify a segment running between each pair of candidate points, and, if the segment does not cross (or intersect) any hard boundaries, add an edge between those points to the graph. The cost of a segment may become the cost of the corresponding graph edge. In such implementations, the candidate points connected by the resulting edge may be included within the same polygon. In this way, pathfinding component 116 may be configured to employ the techniques described herein to identify a path between the starting point and the ending point regardless of the number of polygons a game object must pass through or travel within or the complexity of those polygons (e.g., the number of hard boundaries based on the shape of the area to which they correspond).

In some implementations, after identifying an optimal path as described above, pathfinding component 116 may be configured to perform one or more optimization techniques to search for an improved solution in a vicinity of the boundary point (or additional routing point) through which a path was found using techniques described above. For example, after identifying the path through routing point 6 as the optimal path in the example implementation depicted in FIG. 3, pathfinding component 116 may be configured to search for an improved solution in a vicinity of routing point 6. In some implementations, when there is only one boundary point on a projected path, pathfinding component 116 may be configured to use a single-variable optimization method, such as golden-section search or ternary search method. In other implementations when there is more than one boundary point on a projected path, pathfinding component 116 may be configured to use a multi-variable optimization method. For example, pathfinding component 116 may be configured to use one or more existing methods, such as gradient descent, simulated annealing, an evolutionary algorithm, a genetic algorithm, and/or one or more other existing multi-variable optimization methods. In some implementations, pathfinding component 116 may apply one or more of the afore-mentioned multi-variable optimization methods to a single variable (i.e., when there is only one boundary point on a projected path).

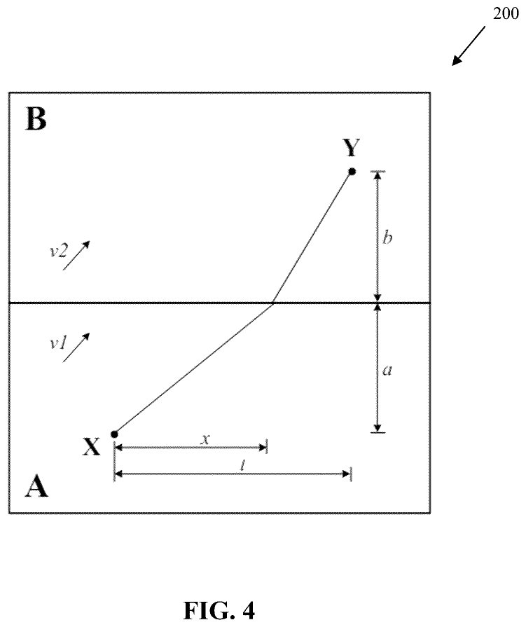

In some implementations, pathfinding component 116 may be configured to perform per-segment optimization techniques to search for an improved solution. For example, FIG. 4 depicts two-dimensional polygon space 200 with variables included that are used to perform per-segment optimization, according to one or more aspects described herein. In some implementations, to perform per-segment optimization, for each segment of a path that involves a boundary point (i.e., a point between two polygons), pathfinding component 116 may be configured to calculate an optimal boundary point between points of the path in the adjacent polygons (e.g., between point X and point Y in polygon A and polygon B, respectively) according to Snell's Law. In some implementations, pathfinding component 116 may be configured to find a coordinate (x) using the following equation:

$$\frac{x}{v 1 \sqrt{{x}^{2} + {a}^{2}}} = \frac{l - x}{v 2 \sqrt{{( l - x )}^{2} + {b}^{2}}} ,$$

(which may be obtained by differentiating time

$$T = \frac{\sqrt{{x}^{2} + {a}^{2}}}{v 1} + \frac{\sqrt{{b}^{2} + {( l - x )}^{2}}}{v 2}$$

necessary to reach from X to Y and finding a value of x where the derivative becomes 0), where x, a, b, and l are shown in FIG. 4. In various implementations, pathfinding component 116 may be configured to find coordinate (x) numerically (using any known method for finding a root of the above equation) or symbolically (using one or more techniques described, for example, in “Computationally Efficient Solution of Snell's Law of Refraction” by Jerzy Dziewierz and Anthony Gachagan, which was published in IEEE Transactions on Ultrasonics, Ferroelectrics, and Frequency Control, vol. 60, no. 6, in June 2013, the content of which is herein incorporated by reference in its entirety. In such implementations, pathfinding component 116 may then be configured to determine whether the calculated boundary point lies on a boundary segment between polygons A and B, and that path segments going through the calculated boundary point do not cross any hard boundaries. If the calculated boundary point is not on the boundary segment, pathfinding component 116 may be configured to adjust the calculated boundary point to a nearest end of the boundary, and if related segment(s) cross some hard boundaries, the calculated boundary point may be adjusted to avoid such intersections. In such implementations, pathfinding component 116 may then be configured to replace a boundary point in a path as an optimal boundary point. In various implementations, pathfinding component 116 may be configured to verify that an updated path is a valid path (i.e., that none of the segments of the path crosses any hard boundaries). If the path is a valid path, the identified path represents a more optimal path.

When there is more than one boundary point on a projected path, pathfinding component 116 may be configured to repeat the process multiple times. For example, if a projected path between target points goes from polygon A through polygon B and into polygon C, pathfinding component 116 may be configured perform optimization for a boundary point between polygon A and polygon B, perform optimization for a boundary point between polygon B and polygon C, and then again for a boundary point between polygon A and polygon B and a boundary point between polygon B and polygon C. This process of going through the different boundary points and optimizing them one by one (while using already optimized positions of some of the points) may be repeated several times, until a most optimal path is identified.

In some online games, there may circumstances where several polygons to be traversed may be associated with the same speed, but have different attributes that are not relevant to pathfinding, such as visibility and/or other attributes that may be associated with an area within an online game. In such implementations, once a path between the two or more polygons with the same speed is determined, pathfinding component 116 may be configured to adjust (or straighten) corresponding segments of the identified path. For example, pathfinding component 116 may be configured to identify a first point of a path within the two or more polygons with the same speed to a last point of the path within the two or more polygons with the same speed, and determine whether a segment that goes directly from the first point to the last point (in a straight line) is valid (i.e., that the path does not cross any hard boundaries). If pathfinding component 116 determines that the segment is valid, pathfinding component 116 may be configured to replace corresponding part of a projected path through two or more polygons with a single segment. If pathfinding component 116 determines that the segment is invalid but crosses two or more polygons with same speed, pathfinding component 116 may join other path edges and/or segments which belong to the polygons with the same speed.

In the description above, pathfinding component 116 was building the entire graph before running a graph search algorithm such as, for example, one of the A* family of graph search methods. In various implementations, pathfinding component 116 may be configured to generate a graph, which is conceptually similar to the graph described above, at certain points within a graph search algorithm. In other words, pathfinding component 116 may be configured to avoid building the entire graph in advance. Instead, pathfinding component 116 may be configured to build the graph while performing a graph search method, such as A* or another graph traversal and path search algorithm. More specifically, pathfinding component 116 may be configured to generate a graph using local traversing while performing graph search method. For example, in some implementations, pathfinding component 116 may be configured to identify additional routing points as described herein, but skip analyzing the segments temporarily. In such implementations, pathfinding component 116 may be configured to perform a graph search method (such as A* or another method based on another graph traversal and path search algorithm). During execution of the graph search method, the graph search method may be configured to perform local traversing by finding (and analyzing) all the neighbors of a specific node X. In some implementations, such traversing may be substantially local in that only local edges (or segments) are analyzed. In such implementations, pathfinding component 116 may be configured to further (or optionally) determine whether a cache of valid paths includes any data related to node X. In some implementations, pathfinding component 116 may be configured to identify all the valid edges coming from node X. For example, in some implementations, pathfinding component 116 may be configured to remove any edges corresponding to paths that cross hard boundaries. In some implementations, pathfinding component 116 may be configured to remove any edges corresponding to paths that go from one polygon to another polygon with a different speed, without having one of the points on the boundary. In various implementations, pathfinding component 116 may be configured to calculate a cost for each edge as a length or time for the corresponding segment, using one or more techniques described herein. In some implementations, pathfinding component 116 may be configured to store identified valid paths with their corresponding weight (or cost) in a cache memory of valid paths. In such implementations, the cache may be an associative array with node ID being a key. Using this technique, memory requirements and overall execution time may be reduced.

In various implementations, virtual scene rendering component 118 may be configured to render a game object within an online game based on a path identified by pathfinding component 116. For example, virtual scene rendering component 118 may be configured to cause a game object (represented, for example, by a mesh with UV-mapped textures) to move within an online game between a starting point and identified end point (i.e., between two target points) along a path identified by pathfinding component 116.

While various operations are described herein as being performed by the client computer system 110 (or one or more components of client computer system 110), it is to be understood that, unless explicitly indicated otherwise, each of the one or more operations described herein as being performed by a client computer system 110 could be performed by a game server 140. For example, one or more techniques described as being used by client computing device 110 to identify a path for a game object in an online game could also (or instead) be used by game server 140 to identify a path for a game object in an online game.

Electronic storage 130 may include electronic storage media that electronically stores and/or transmits information. The electronic storage media of electronic storage 130 may be provided integrally (i.e., substantially nonremovable) with one or more components of system 100 and/or removable storage that is connectable to one or more components of system 100 via, for example, a port (e.g., USB port, a Firewire port, and/or other port) or a drive (e.g., a disk drive and/or other drive). Electronic storage 130 may include one or more of optically readable storage media (e.g., optical disks and/or other optically readable storage media), magnetically readable storage media (e.g., magnetic tape, magnetic hard drive, floppy drive, and/or other magnetically readable storage media), electrical charge-based storage media (e.g., EPROM, EEPROM, RAM, and/or other electrical charge-based storage media), solid-state storage media (e.g., flash drive and/or other solid-state storage media), and/or other electronically readable storage media. Electronic storage 130 may be a separate component within system 100, or electronic storage 130 may be provided integrally with one or more other components of system 100 (e.g., computer system 110 or processor 112). Although electronic storage 130 is shown in FIG. 1 as a single entity, this is for illustrative purposes only. In some implementations, electronic storage 130 may comprise a plurality of storage units. These storage units may be physically located within the same device, or electronic storage 130 may represent storage functionality of a plurality of devices operating in coordination.

Electronic storage 130 may store software algorithms, information determined by processor 112, information received remotely, and/or other information that enables system 100 to function properly. For example, electronic storage 130 may store standard three-dimensional meshes or models, information relating to one or more three-dimensional meshes or models, one or more meshes, one or more textures, one or more normal maps, and/or other information related to the systems and methods described herein.

Game server 140 may comprise a remote server configured to provide instructions and game state data related to an online game comprising three-dimensional virtual scenes to client computer system 110. In some implementations, game server 140 may be configured to provide to client computer system 110 instructions related to an online game that include instructions to render a three-dimensional object within a virtual scene. For example, the instructions may include an instruction to construct a virtual scene comprising at least one object to be generated based on a base mesh, a base texture, and one or more texture overlay embedded or stored on client computer system 110. In various implementations, game server 140 may be configured as a server device (e.g., having one or more server blades, processors, etc.) and/or as another device capable of providing instructions and game state data related to an online game to client computer system 110.

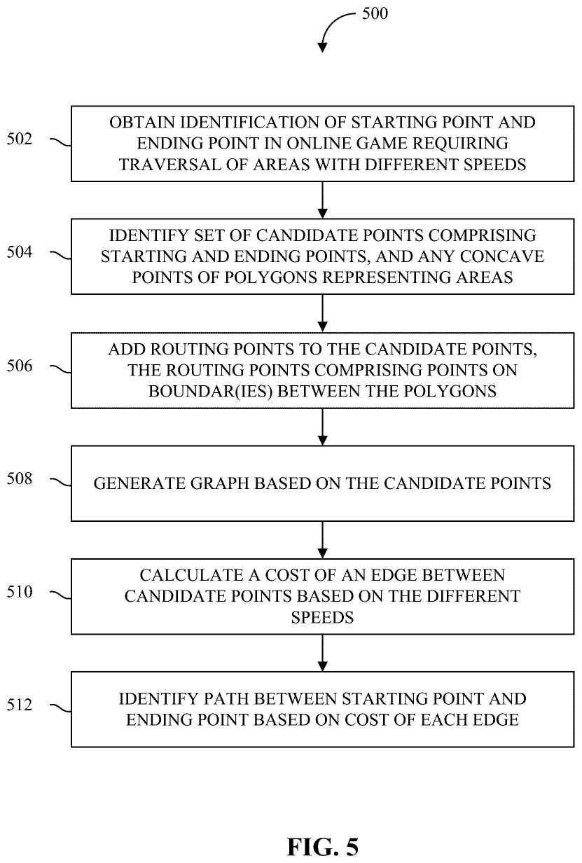

FIG. 5 depicts a flow diagram of an example of a process 500 for identifying a path for a game object in two-dimensional polygon space having polygons associated with different movement speeds, according to one or more aspects described herein. The operations of process 500 presented below are intended to be illustrative and, as such, should not be viewed as limiting. In some implementations, process 500 may be accomplished with one or more additional operations not described, and/or without one or more of the operations discussed. In some implementations, two or more of the operations of process 500 may occur substantially simultaneously. The described operations may be accomplished using some or all of the system components described in detail above.

In an operation 502, process 500 may include obtaining an identification of a starting point and an ending point between which a game object is to travel in an online game. In various implementations, the starting point may be located in a first area within the online game, and the ending point may be located in a second area within the online game. In various implementations, the first area may be represented by a first two-dimensional polygon, and the second area may be represented by a second two-dimensional polygon. In various implementations, traveling between the starting point and the ending point in the online game may require traversing two or more areas within the online game associated with different speeds. For example, in some implementations, the starting point may be located in a first area within the online game associated with a first movement speed, and the ending point may be located in a second area associated with a second movement speed. In such implementations, the first movement speed may be different than the second movement speed. In other implementations, however, the first area and the second area may be associated with the same movement speed and at least one other area through which the game object may pass to travel between the starting point and the ending point may be associated with a different movement speed. Further, in other implementations, the first area, the second area, and one or more other areas through which the game object may pass to travel between the starting point and the ending point may each be associated with a different movement speed. As such, in various implementations, at least one area (represented by a polygon) through which the game object may pass to travel between the starting point and the ending point (e.g., the first area in which the starting point is located or another area) is associated with a first movement speed, and at least one other area (represented by a polygon) through which the game object may pass to travel between the starting point and the ending point (e.g., the second area in which the ending point is located or another area) is associated with a second movement speed.

In an operation 504, process 500 may include identifying a set of candidate points. In various implementations, the set of candidate points may include at least points associated with the starting point and ending point. In various implementations, the set of candidate points may also include any concave points of the first polygon, the second polygon, and any other polygons through which the game object may pass to travel between the starting point and the ending point.

In an operation 506, process 500 may include adding to the candidate points additional routing points located on any of the one or more boundaries between the first polygon, the second polygon, and any other polygons through which the game object may pass to travel between the starting point and the ending point. For example, in various implementations, a set of routing points may be added on the boundary between a first polygon and a second polygon. In other implementations in which traveling between the starting point and the ending point requires traveling through or within more than two areas (or polygons), a set of routing points may be added on each boundary between each contiguous pair of polygons through which the game object may pass to travel between the starting point and the ending point. In some implementations, the set of routing points may be equally spaced apart along the boundary between the polygons. In some implementations, the set of additional routing points may include only routing points for which a segment between the routing point and at least one of the candidate points does not exceed a maximum segment size. In some implementations, the maximum segment size may be based on a maximum distance between a candidate point and the routing point. In some implementations, the maximum segment size may be based on a maximum time to travel between a candidate point and the routing point.

In an operation 508, process 500 may include generating a graph based on the set of candidate points. In various implementations, the graph may be used to identify a path through a two-dimensional polygon space representing one or multiple areas within an online game. For example, the two-dimensional polygon space may include at least a first polygon associated with the first area and a second polygon associated with the second area. In some implementations, the two-dimensional polygon space may also include one or more other polygons associated with other areas through which the game object may pass to travel between the starting point and the ending point. In various implementations, the graph may include any of the candidate points described above, including a point associated with the starting point, a point associated with the ending point, points associated with concave points of the first polygon, the second polygon, and any other polygons through which the game object may pass to travel between the starting point and the ending point, and points associated with routing points.

In addition to points, the generated graph may include edges. In some implementations, in an operation 508, process 500 may take all pairs of candidate points, and for each pair, it may check if a line segment between the points in the pair crosses any hard boundaries, and if the segment does not cross any of the hard boundaries, include a corresponding edge to the graph. In other words, in various implementations, edges which cross hard boundaries may be filtered out or otherwise not included in the generated graph.

In an operation 510, process 500 may include calculating a cost associated with individual segments between the candidate points. In various implementations, for each polygon in which at least one candidate point is located, a cost may be calculated for the segment (or an edge associated with that segment) between candidate points. In various implementations, the cost of an edge between two candidate points may correspond to a minimum time required to travel between the points. In various implementations, the cost of an edge may be calculated by dividing a length of an edge by a movement speed associated with the polygon in which the corresponding segment is located.

In an operation 512, process 500 may include identifying a path in the online game between the starting point and the ending point based on the calculated costs for the edges. For example, an optimal path may be identified based on the cost of each of the first set of edges and each of the second set of edges. In such implementations, the identified path may include at least a first portion within the first area corresponding to one of the first set of edges and a second portion within the second area corresponding to one of the second set of edges. In various implementations, the first and second portions of the path may be connected by a routing point. In various implementations, the path in the online game between the starting point and the ending point may be identified by performing a graph search method using the graph generated in operations 506-508. In some implementations, the graph search method may comprise one of the A* family of graph search methods.

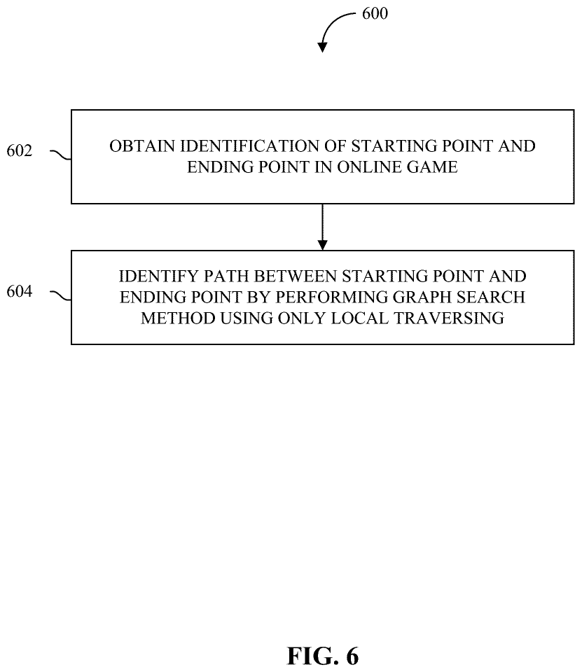

FIG. 6 depicts a flow diagram of an example of a process 600 for identifying a path for a game object in two-dimensional polygon space by performing a graph search method using only local traversing, according to one or more aspects described herein. The operations of process 600 presented below are intended to be illustrative and, as such, should not be viewed as limiting. In some implementations, process 600 may be accomplished with one or more additional operations not described, and/or without one or more of the operations discussed. In some implementations, two or more of the operations of process 600 may occur substantially simultaneously. The described operations may be accomplished using some or all of the system components described in detail above.

In an operation 602, process 600 may include obtaining an identification of a starting point and an ending point between which a game object is to travel in an online game. In various implementations, the starting point may be located in a first area within the online game, and the ending point may be located in a second area within the online game. In various implementations, the first area may be represented by a first two-dimensional polygon, and the second area may be represented by a second two-dimensional polygon. In various implementations, traveling between the starting point and the ending point in the online game may require traversing two or more areas within the online game associated with different speeds. For example, in some implementations, the starting point may be located in a first area within the online game associated with a first movement speed, and the ending point may be located in a second area associated with a second movement speed. In such implementations, the first movement speed may be different than the second movement speed. In other implementations, however, the first area and the second area may be associated with the same movement speed and at least one other area through which the game object may pass to travel between the starting point and the ending point may be associated with a different movement speed. Further, in other implementations, the first area, the second area, and one or more other areas through which the game object may pass to travel between the starting point and the ending point may each be associated with a different movement speed. As such, in various implementations, at least one area (represented by a polygon) through which the game object may pass to travel between the starting point and the ending point (e.g., the first area in which the starting point is located or another area) is associated with a first movement speed, and at least one other area (represented by a polygon) through which the game object may pass to travel between the starting point and the ending point (e.g., the second area in which the ending point is located or another area) is associated with a second movement speed.

In an operation 604, process 600 may include identifying a path in the online game between the starting point and the ending point by performing a graph search method using only local traversing. In various implementations, such an operation may include determining a cost of only graph edges between the starting point and any neighboring points and between any neighboring points and subsequent neighboring points until the ending point is reached. In various implementations, a cost may be determined for only graph edges that do not cross from a polygon representing a one area within the online game associated with a first movement speed and another polygon representing another area within the online game associated with a second movement speed. In some implementations, determining the cost of a graph edge may include determining whether the graph edge is included within a cache of valid graph edges. In some implementations, determining the cost of a graph edge may include calculating a cost of the graph edge by dividing a length of the graph edge by a movement speed associated with an area in which the graph edge is located within the online game. In various implementations, the graph search method may comprise one of the A* family of graph search methods.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific example aspects and implementations of the disclosure, and performing certain actions.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application—such as by using any combination of digital processors, analog processors, digital circuits designed to process information, central processing units, graphics processing units, microcontrollers, microprocessors, field programmable gate arrays (FPGAs), application specific transformed circuits (ASICs), a System on a Chip (SoC), and/or other mechanisms for electronically processing information—but such implementation decisions should not be interpreted as causing a departure from the scope of the present invention.

The description of the functionality provided by the different computer-readable instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 112 may be programmed by one or more additional instructions that may perform some or all of the functionality attributed herein to one of the computer-readable instructions.

The various instructions described herein may be stored in electronic storage, which may comprise random access memory (RAM), read only memory (ROM), and/or other memory. In some implementations, the various instructions described herein may be stored in electronic storage of one or more components of system 100 and/or accessible via a network (e.g., via the Internet, cloud storage, and/or one or more other networks). The electronic storage may store the computer program instructions (e.g., the aforementioned instructions) to be executed by processor(s) 112 as well as data that may be manipulated by processor(s) 112. The electronic storage may comprise floppy disks, hard disks, optical disks, tapes, or other storage media for storing computer-executable instructions and/or data.

Although illustrated in FIG. 1 as a single component, client computer system 110 and game server 140 may each include a plurality of individual components (e.g., computer devices) each programmed with at least some of the functions described herein. In this manner, some components of client computer system 110 and/or associated client computing device(s) may perform some functions while other components may perform other functions, as would be appreciated. Furthermore, it should be appreciated that although the various instructions are illustrated in FIG. 1 as being co-located within a single processing unit, in implementations in which processor(s) 112 include multiple processing units, one or more instructions may be executed remotely from the other instructions.

One or more components of system 100 may communicate with each other through hard-wired communication, wireless communication, or both. In various implementations, one or more components of system 100 may communicate with each other through a network. For example, client computer system 110 and/or game server 140 may wirelessly communicate with electronic storage 130. By way of non-limiting example, wireless communication may include one or more of radio communication, Bluetooth communication, Wi-Fi communication, cellular communication, infrared communication, or other wireless communication. Other types of communications are contemplated by the present disclosure.

Although client computer system 110, electronic storage 130, and game server 140 are shown to be connected to interface 102 in FIG. 1, any communication medium may be used to facilitate interaction between any components of system 100. For example, as referred to herein, interface 102 may comprise a network via which client computer system 110 may transmit packets or otherwise communicate with game server 140. In some implementations, the connections forming the network represented by interface 102 may include Asymmetric Digital Subscriber Line (ADSL), Symmetric Digital Subscriber Line (SDSL), cable, 3G, 4G, LTE, Ethernet, or any other existing or future developed systems and/or methods of communication with similar functionalities. In some implementations, one or multiple connections may be used to facilitate communication (e.g., transmit packets) between client computer system 110 and game server 140. Indeed, while described herein as a single interface 102 for simplicity, interface 102 may include one or multiple physical and/or virtual interfaces via which packets may be sent from client computer system 110 to game server 140, and vice versa. For example, multiple connections forming a Local Area Network (LAN), Intranet, or Internet may be used to facilitate communication between client computer system 110 and game server 140.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A computer-implemented method of identifying a path for a game object in two-dimensional polygon space having polygons associated with different movement speeds, the method comprising:
obtaining an identification of a starting point and an ending point between which a game object is to travel in an online game, wherein the starting point is located in a first area associated with a first movement speed and the ending point is located in a second area associated with a second movement speed, wherein the first area is represented by a first two-dimensional polygon, and the second area is represented by a second two-dimensional polygon;
identifying a set of candidate points, wherein the set of candidate points include points based on the starting point, the ending point, and any concave points of the first polygon and the second polygon;
adding, to the set of candidate points, a set of routing points comprising points on a boundary between the first polygon and the second polygon;
generating a graph based on the set of candidate points, wherein the graph includes edges between candidate points;
calculating a cost of each of the graph edges; and
identifying a path in the online game between the starting point and the ending point based on the cost of each the edges, wherein the path includes a first portion within the first polygon and a second portion within the second polygon.

2. The computer-implemented method of claim 1, wherein the first movement speed is different than the second movement speed.

3. The computer-implemented method of claim 1, wherein the cost of an edge corresponding to the first portion of the path is based on a minimum time required to travel between the starting point and a corresponding one of the set of routing points, and wherein the cost of an edge corresponding to the second portion of the path is based on a minimum time required to travel between a corresponding one of the set of routing points and the ending point.

4. The computer-implemented method of claim 3, wherein calculating the cost of the edge corresponding to the first portion of the path comprises dividing a length of the edge by the first movement speed.

5. The computer-implemented method of claim 1, wherein identifying the path in the online game between the starting point and the ending point based on the cost of each of the edges comprises performing a graph search method.

6. The computer-implemented method of claim 5, wherein the graph search method comprises one of the A* family of graph search methods.

7. The computer-implemented method of claim 1, wherein the set of routing points are equally spaced apart along the boundary between the first polygon and the second polygon.

8. The computer-implemented method of claim 1, wherein the set of routing points include only routing points for which an edge between the routing point and at least one of the candidate points does not exceed a maximum segment size.

9. The computer-implemented method of claim 8, wherein the maximum segment size is based on a maximum distance between a candidate point and the routing point.

10. The computer-implemented method of claim 8, wherein the maximum segment size is based on a maximum time to travel between a candidate point and the routing point.

11. A computer-implemented method of identifying a path for a game object in two-dimensional polygon space, the method comprising:
obtaining an identification of a starting point and an ending point between which a game object is to travel in an online game; and
identifying a path in the online game between the starting point and the ending point by performing a graph search method using only local traversing, wherein performing the graph search method using only local traversing comprises determining a cost of only graph edges between the starting point and any neighboring points and between any neighboring points and subsequent neighboring points until the ending point is reached.

12. The computer-implemented method of claim 11, wherein the starting point is located in a first area associated with a first movement speed and the ending point is located in a second area associated with a second movement speed, wherein the first area is represented by a first two-dimensional polygon, and the second area is represented by a second two-dimensional polygon, wherein performing the graph search method using only local traversing comprises determining a cost of only graph edges that do not cross from the first polygon to the second polygon.

13. The computer-implemented method of claim 11, wherein determining the cost of only graph edges between the starting point and any neighboring points and between any neighboring points and subsequent neighboring points until the ending point is reached comprises determining whether one or more of the individual graph edges are included within a cache of valid graph edges.

14. The computer-implemented method of claim 11, wherein determining the cost of only graph edges between the starting point and any neighboring points and between any neighboring points and subsequent neighboring points until the ending point is reached comprises calculating the cost of at least one graph edge, wherein calculating the cost of the at least one graph edge comprises dividing a length of the graph edge by a movement speed associated with an area in which the graph edge is located within the online game.

15. The computer-implemented method of claim 11, wherein the graph search method comprises one of the A* family of graph search methods.

16. A system for identifying a path for a game object in two-dimensional polygon space having polygons associated with different movement speeds, the system comprising:
one or more processors configured by computer readable instructions to:
obtain an identification of a starting point and an ending point between which a game object is to travel in an online game, wherein the starting point is located in a first area associated with a first movement speed and the ending point is located in a second area associated with a second movement speed, wherein the first area is represented by a first two-dimensional polygon, and the second area is represented by a second two-dimensional polygon;
identify a set of candidate points, wherein the set of candidate points include points based on the starting point, the ending point, and any concave points of the first polygon and the second polygon;
add, to the set of candidate points, a set of routing points comprising points on a boundary between the first polygon and the second polygon;
generate a graph based on the set of candidate points, wherein the graph includes edges between candidate points;
calculate a cost of each of the graph edges; and
identify a path in the online game between the starting point and the ending point based on the cost of each the edges, wherein the path includes a first portion within the first polygon and a second portion within the second polygon.

17. The system of claim 16, wherein the first movement speed is different than the second movement speed.

18. The system of claim 16, wherein the cost of an edge corresponding to the first portion of the path is based on a minimum time required to travel between the starting point and a corresponding one of the set of routing points, and wherein the cost of an edge corresponding to the second portion of the path is based on a minimum time required to travel between a corresponding one of the set of routing points and the ending point.

19. The system of claim 18, wherein to calculate the cost of the edge corresponding to the first portion of the path, the one or more processors are configured to divide a length of the edge by the first movement speed.

20. The system of claim 16, wherein to identify the path in the online game between the starting point and the ending point based on the cost of each of the edges, the one or more processors are configured to perform a graph search method.

21. The system of claim 20, wherein the graph search method comprises one of the A* family of graph search methods.

22. The system of claim 16, wherein the set of routing points are equally spaced apart along the boundary between the first polygon and the second polygon.

23. The system of claim 16, wherein the set of routing points include only routing points for which an edge between the routing point and at least one of the candidate points does not exceed a maximum segment size.

24. The system of claim 23, wherein the maximum segment size is based on a maximum distance between a candidate point and the routing point.

25. The system of claim 23, wherein the maximum segment size is based on a maximum time to travel between a candidate point and the routing point.

26. A system for identifying a path for a game object in two-dimensional polygon space, the system comprising:
one or more processors configured by computer readable instructions to:
obtain an identification of a starting point and an ending point between which a game object is to travel in an online game; and
identify a path in the online game between the starting point and the ending point by performing a graph search method using only local traversing, wherein to perform the graph search method using only local traversing, the one or more processors are configured to determine a cost of only graph edges between the starting point and any neighboring points and between any neighboring points and subsequent neighboring points until the ending point is reached.

27. The system of claim 26, wherein the starting point is located in a first area associated with a first movement speed and the ending point is located in a second area associated with a second movement speed, wherein the first area is represented by a first two-dimensional polygon, and the second area is represented by a second two-dimensional polygon, wherein to perform the graph search method using only local traversing, the one or more processors are configured to determine a cost of only graph edges that do not cross from the first polygon to the second polygon.

28. The system of claim 26, wherein to determine the cost of only graph edges between the starting point and any neighboring points and between any neighboring points and subsequent neighboring points until the ending point is reached, the one or more processors are configured to determine whether one or more of the individual graph edges are included within a cache of valid graph edges.

29. The system of claim 26, wherein to determine the cost of only graph edges between the starting point and any neighboring points and between any neighboring points and subsequent neighboring points until the ending point is reached, the one or more processors are configured to calculate the cost of at least one graph edge, wherein to calculate the cost of the at least one graph edge, the one or more processors are configured to divide a length of the graph edge by a movement speed associated with an area in which the graph edge is located within the online game.

30. The system of claim 26, wherein the graph search method comprises one of the A* family of graph search methods.
